(19) United States
(12) Patent Application Publication
(10) Pub. No.: US 2023/0206085 A1
(43) Pub. Date: Jun. 29, 2023

(54) PROCESSING DEVICE, PROCESSING METHOD AND PROCESSING PROGRAM

(71) Applicant: Nippon Telegraph and Telephone Corporation, Tokyo (JP)

(72) Inventors: Osamu Saisho, Musashino-shi, Tokyo (JP); Takeshi OGURO, Musashino-shi, Tokyo (JP); Jingyu SUN, Musashino-shi, Tokyo (JP); Hiroshi IMAMURA, Musashino-shi, Tokyo (JP); Susumu TAKEUCHI, Musashino-shi, Tokyo (JP); Daigoro Yokozeki, Musashino-shi, Tokyo (JP)

(21) Appl. No.: 17/928,155

(22) PCT Filed: Jun. 5, 2020
(86) PCT No.: PCT/JP2020/022366

§ 371 Date: Nov. 28, 2022

(51) Int. Cl. G06N 5/022

(52) U.S. Cl. CPC G06N 5/022

(57) ABSTRACT

A processing device includes: a first processing unit that refers to function data including a labeling function that labels an input dataset or abstain if it cannot label, to output first output data that associates each input dataset with a probability of corresponding to each label from a result of labeling the input dataset by the labeling function; and an identifying unit that identifies an input dataset in which a variation in the probability of corresponding to each label in the first output data satisfies a predetermined condition among the input datasets. A labeling function newly created for the input dataset identified from the first output data by the identifying unit is inserted into the function data.

### TECHNICAL FIELD

The present invention relates to a processing device, a processing method, and a processing program.

### BACKGROUND ART

Machine learning, especially so-called supervised learning, is widespread in a wide range of fields. In supervised learning, a training dataset with a correct answer assigned to input dataset is prepared in advance, and a discriminator performs learning based on the training dataset. The cost required for creating a training dataset with the correct answer is a problem in machine learning.

Active learning and weakly supervised learning, in which training datasets are added by computer processing, are proposed.

In active learning, when using existing training datasets and a discriminator, a dataset that improves the performance of the discriminator when the correct answer is known is presented from among an input dataset group without correct answers. The presented dataset will be assigned with the correct answer and added to the training dataset.

In weakly supervised learning, a function corresponding to the rule based on the knowledge of the subject who assigns the correct answer is implemented in a system, and the system assigns the correct answer to the input dataset according to the function. The dataset with the correct answer is added to the training dataset.

In weakly supervised learning, there is also a technique for adding rules in a manner similar to active learning (Non-Patent Literature 1). Non-Patent Literature 1 extracts an input dataset in which the majority vote of the output is uncertain or no vote is taken when the implemented rule is applied to the input dataset group. A rule to get the correct answer is added to the input dataset randomly selected from the extracted input dataset.

### CITATION LIST

### Non-Patent Literature

Non-Patent Literature 1: Benjamin Cohen-Wang, and three others, “Interactive Programmatic Labeling for Weak Supervision”, August 4-8, 2019, Workshop at KDD

### SUMMARY OF THE INVENTION

### Technical Problem

However, the method described in Non-Patent Literature 1 does not make use of the method of weakly supervised learning in consideration of dealing with duplication and inconsistency between rules. Since rules are added to input datasets randomly extracted from input datasets in which the majority vote of the output is uncertain or no vote is taken, it may be difficult to realize efficient learning such as taking time to add rules appropriately.

The present invention has been made in view of the above circumstances, and an objective of the present invention is to provide a technique capable of appropriately presenting an input dataset to which a correct answer should be assigned in weakly supervised learning.

### Means for Solving the Problem

A processing device according to an aspect of the present invention includes: a first processing unit that refers to function data including a labeling function that labels an input dataset or abstain if it cannot label, to output first output data that associates each input dataset with a probability of corresponding to each label from a result of labeling the input dataset by the labeling function; and an identifying unit that identifies an input dataset in which a variation in the probability of corresponding to each label in the first output data satisfies a predetermined condition among the input datasets, wherein a labeling function newly created for the input dataset identified from the first output data by the identifying unit is inserted into the function data.

A processing method according to an aspect of the present invention causes a computer to execute: referring to function data including a labeling function that labels an input dataset or abstain if it cannot label, to output first output data that associates each input dataset with a probability of corresponding to each label from a result of labeling the input dataset by the labeling function; and identifying an input dataset in which a variation in the probability of corresponding to each label in the first output data satisfies a predetermined condition among the input datasets, wherein a labeling function newly created for the input dataset identified from the first output data in the identifying step is inserted into the function data.

Another aspect of the present invention provides a processing program that causes a computer to function as the processing device.

### EFFECT OF THE INVENTION

According to the present invention, it is possible to provide a technique capable of appropriately presenting an input dataset to which a correct answer should be assigned in weakly supervised learning.

### BRIEF DESCRIPTION OF DRAWINGS

FIG. 1 is a diagram illustrating a functional block of a processing device according to a first embodiment.

FIG. 2 is a diagram illustrating an example of a data structure of input data.

FIG. 3 is a diagram illustrating an example of a data structure of function data.

FIG. 4 is a flowchart illustrating an outline of processing by the processing device according to the first embodiment.

FIG. 5 is a diagram illustrating an example of a data structure of labeled input data.

FIG. 6 is a diagram illustrating an example of a data structure of first output data.

FIG. 7 is a flowchart illustrating an outline of processing by a first processing unit according to the first embodiment.

FIG. 8 is a diagram illustrating a functional block of a processing device according to a second embodiment.

FIG. 9 is a flowchart illustrating an outline of processing by the processing device according to the second embodiment.

FIG. 10 is a diagram illustrating an example of a data structure of training data.

FIG. 11 is a flowchart illustrating an outline of processing by a second processing unit according to the second embodiment.

FIG. 12 is a diagram illustrating a functional block of a processing device according to a third embodiment.

FIG. 13 is a flowchart illustrating an outline of processing by the processing device according to the third embodiment.

FIG. 14 is a diagram illustrating a processing result of the processing device.

FIG. 15 is a diagram illustrating a hardware configuration of a computer used in a processing device.

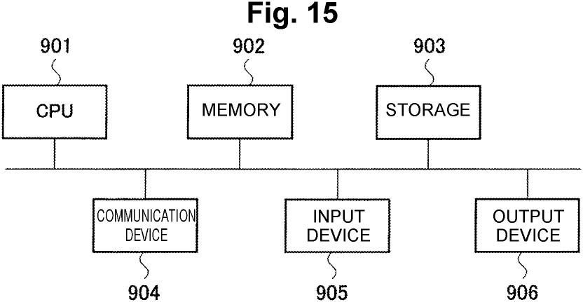

### DESCRIPTION OF EMBODIMENTS

Hereinafter, embodiments of the present invention will be described with reference to the drawings. In the description of the drawings, the same parts are designated by the same reference numerals and the description thereof will be omitted.

### First Embodiment

A processing device 1 according to a first embodiment identifies an input dataset to which a labeling function is given based on an output result of an existing labeling function in weakly supervised learning. The processing device 1 can efficiently generate a labeling function by adding a labeling function for labeling the identified input dataset to the existing labeling function.

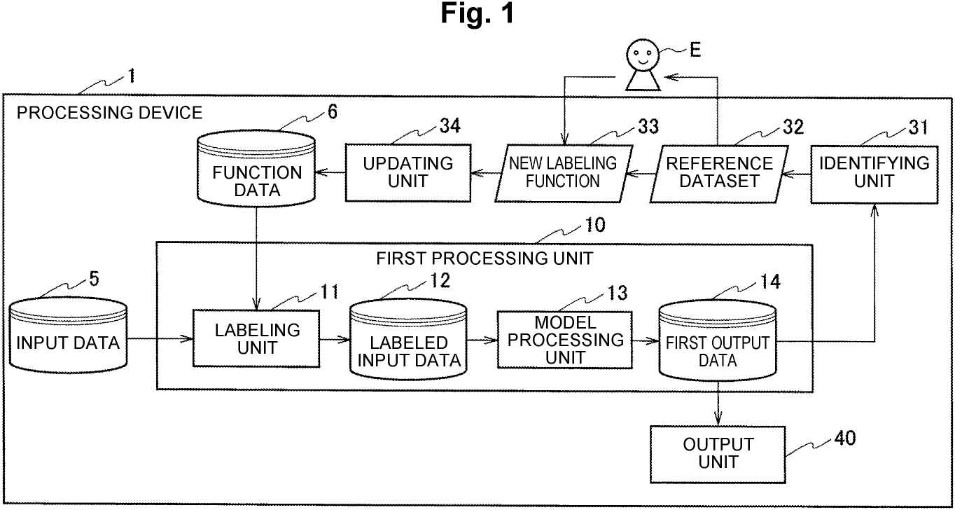

The processing device 1 shown in FIG. 1 includes input data 5, function data 6, a first processing unit 10, an identifying unit 31, a reference dataset 32, a new labeling function 33, an updating unit 34, and an output unit 40. Among these elements, the processing unit is implemented in a CPU 901, and the data is stored in a memory 902 or a storage 903.

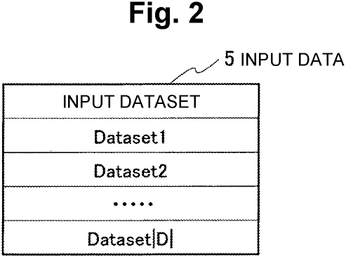

The input data 5 is data to be labeled by the labeling function. As shown in FIG. 2, the input data 5 is a set of a plurality of input datasets. In the embodiment of the present invention, the number of input datasets included in the input data 5 is |D|.

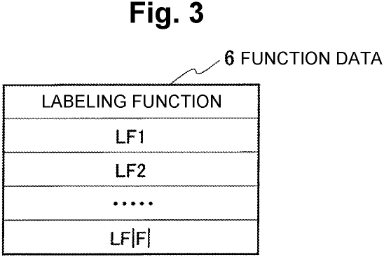

The function data 6 is data of a labeling function that labels the input datasets of the input data 5. The labeling function is a function that labels an input dataset or abstains if it cannot label. As shown in FIG. 3, the function data 6 is a set of a plurality of labeling functions. In the embodiment of the present invention, the number of labeling functions included in the function data 6 is |F|.

The first processing unit 10 outputs first output data 14 that associates each input dataset with the probability of corresponding to each label from the result of labeling the input dataset with the labeling function. Here, a high value is given to the probability of corresponding to the label if determination is made for the labeling function with high reliability that it corresponds to the label, and a low value is given to the probability of corresponding to the label if determination is made for the labeling function with low reliability that it corresponds to the label. The process of the first processing unit 10 outputting the first output data 14 will be described in detail later.

The identifying unit 31 identifies, among the input datasets, an input dataset in which the variation in the probability of corresponding to each label in the first output data 14 satisfies a predetermined condition as reference dataset 32. When the variation in the probability of corresponding to each label is expressed by a predetermined index, the identifying unit 31 identifies an input dataset in which the variation is larger than a predetermined threshold. An input dataset with a large variation in the probability of corresponding to each label has a high priority to be identified as the reference dataset 32, and an input dataset with a small variation in the probability of corresponding to each label has a low priority to be identified as the reference dataset 32. A new labeling function 33 is generated to label the reference dataset 32. The number of input datasets in the reference dataset 32 and the number of functions in the new labeling function 33 are arbitrary.

The new labeling function 33 is generated by an arbitrary subject E. For example, a domain expert may manually generate a labeling function for the reference dataset 32 presented by the identifying unit 31. A computer such as existing machine learning may generate a labeling function by a predetermined program. External knowledge such as an existing ontology may generate a labeling function.

In the updating unit 34, a labeling function newly created for the input dataset identified from the first output data 14 by the identifying unit 31 is inserted into the function data 6. Specifically, the updating unit 34 inserts the new labeling function 33 into the function data 6. As a result, the number of labeling functions included in the function data 6 is larger than |F| and increases by the number of functions in the new labeling function 33.

With reference to the function data 6 to which the new labeling function 33 is added, the first processing unit 10 again labels each input dataset of the input data 5, and outputs the first output data 14 that associates each input dataset with the probability of corresponding to each label.

The updating process of the function data 6 by the first processing unit 10 and the identifying unit 31 and the like is repeated until a predetermined condition is satisfied. As the predetermined condition, a condition indicating that an appropriate labeling function is accommodated in the function data 6 is set. The predetermined condition is determined by, for example, the number of repetitions, the processing time, and the like until the number of datasets of the reference dataset 32 becomes zero.

The output unit 40 outputs a learning result based on the first output data 14 obtained after the predetermined condition is satisfied. After the newly created labeling function is inserted into the function data 6, the output unit 40 outputs the labels corresponding to the highest probability in each of the input datasets in the first output data 14 obtained by executing the first processing unit 10 in an associated manner.

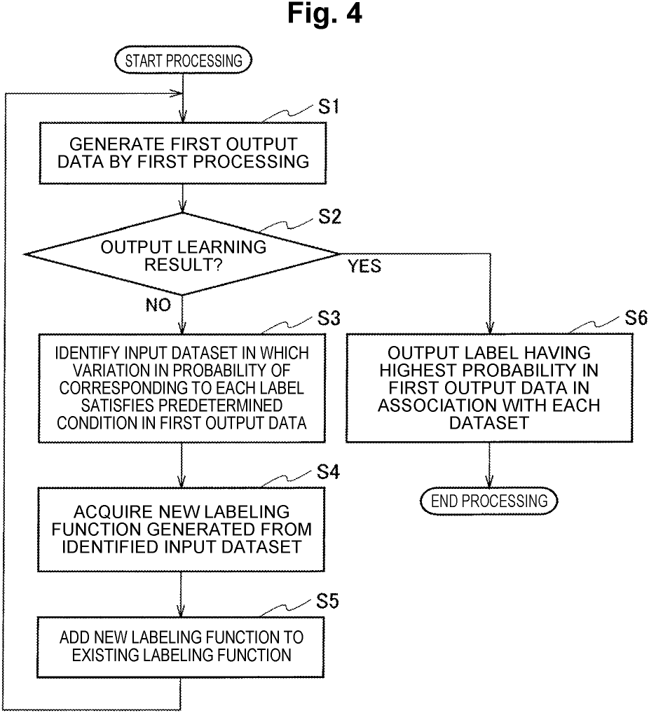

With reference to FIG. 4, the outline of the processing of the processing device 1 according to the first embodiment will be described. The process shown in FIG. 4 is an example and is not limited to this.

First, in step S1, the processing device 1 generates the first output data 14 by the processing of the first processing unit 10. The first output data 14 is data that associates each input dataset with the probability of corresponding to each label.

In step S2, the processing device 1 determines whether or not the function data 6 accommodates an appropriate function and it is the timing to output the learning result. For example, the process proceeds to step S3 when consideration about addition of the labeling function is required, and it is not the timing to output the learning result such as when the process of step S1 is the first time, or the number of datasets in the reference dataset 32 is not zero. On the other hand, the process proceeds to step S6 when addition of the labeling function is not required and it is the timing to output the learning result such as when the process of step S1 is repeated a plurality of times, or the number of datasets of the reference dataset 32 at the previous processing time is zero.

In step S3, the processing device 1 identifies an input dataset in which the variation in the probability of corresponding to each label satisfies a predetermined condition in the first output data 14 as the reference dataset 32. In step S4, the processing device 1 acquires the new labeling function 33 generated for the reference dataset 32 identified in step S3. In step S5, the processing device 1 adds the new labeling function 33 acquired in step S4 to the function data 6 accommodating the existing labeling function. After that, returning to step S1, the processing device 1 refers to the function data 6 to which the new labeling function 33 is added to generate the first output data 14.

In step S6, as a learning result, the processing device 1 associates each input dataset with the label having the highest probability in the first output data 14 and outputs the dataset.

### First Processing Unit

Next, the first processing unit 10 will be described. The first processing unit 10 includes a labeling unit 11, labeled input data 12, a model processing unit 13, and first output data 14.

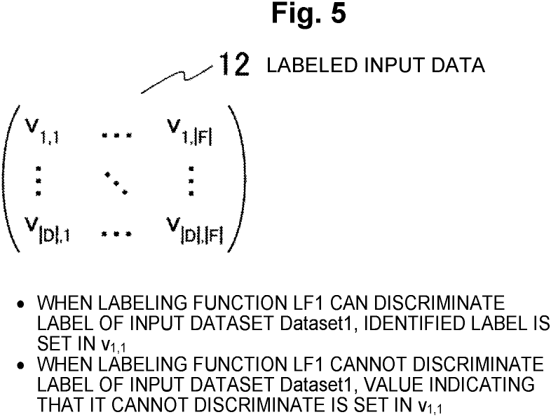

The labeling unit 11 labels each input dataset of the input data 5 with each labeling function of the function data 6, and stores the result as the labeled input data 12. As shown in FIG. 5, the value of the labeled input data 12 is set so as to correspond to the identifier that identifies the input dataset and the identifier that identifies the labeling function. In the example shown in FIG. 5, the first character after the alphabet v is the identifier that identifies the input dataset, and the second character is the identifier of the labeling function that processed the input dataset.

When the label of the corresponding input dataset can be discriminated by the corresponding labeling function, the identifier of the discriminated label is set to the value. On the other hand, when the label of the corresponding input dataset cannot be discriminated by the corresponding labeling function, a value indicating that the label cannot be discriminated is set to the value. The value indicating that it cannot be discriminated is, for example, 0, and a value that is not set by the identifier of the label is set.

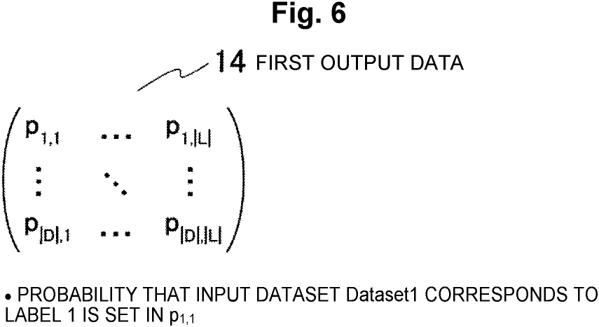

When the labeled input data 12 is generated, the model processing unit 13 generates the first output data 14. The first output data 14 associates each input dataset with the probability of corresponding to each label. As shown in FIG. 6, the value of the first output data 14 is set so as to correspond to the identifier that identifies the input dataset and the identifier that identifies the label. In the example shown in FIG. 6, the first character after the alphabet v is the identifier that identifies the input dataset, and the second character is the identifier of the label corresponding to the input dataset. The example shown in FIG. 6 describes a case where any of |L| labels is assigned to the input dataset.

The model processing unit 13 calculates the probability of corresponding to each label for each input dataset based on the reliability of voting of each labeling function and the duplication and inconsistency that occurs between the labeling functions by a labeling model. The model processing unit 13 returns the probability of corresponding to each label to each input dataset by taking the reliability of each labeling function into consideration so that the label assigned by a function with high reliability has a high probability and the label assigned by a function with low reliability has a low probability. The labeling model is, for example, Snorkel.

Here, an example of processing of the model processing unit 13 will be described for three labeling functions in the identification problem of three labels {1, 2, 3}. The three labeling functions include a first labeling function for discriminating a first label, a second labeling function for discriminating a second label, and a third labeling function for discriminating a third label, respectively. As for the reliability of each labeling function, it is assumed that the first labeling function has the highest reliability and the third labeling function has the lowest reliability. Further, each labeling function returns the identifier of the discriminated label when the label can be discriminated, and returns 0 when the labeling function cannot discriminate the label and abstains. The model processing unit 13 outputs the probabilities of corresponding to the first to third labels for one input dataset.

For example, if the discrimination results of the three labeling functions for a certain input dataset are {1, 0, 0}, the model processing unit 13 outputs the probabilities of {0.7, 0.15, 0.15} as the probability of corresponding to each label by taking the reliability of the labeling function into consideration. When the discrimination results of the three labeling functions for another input dataset are {0, 0, 1}, the model processing unit 13 outputs the probabilities of {0.25, 0.25, 0.5} as the probability of corresponding to each label. A high probability is set for the discrimination result of a labeling function with high reliability, and a low probability is set for the discrimination result of the labeling function with low reliability.

A case where an inconsistency that the first labeling function discriminates one input dataset as a first label whereas the third labeling function discriminates the same as a third label, such as the determination result is {1, 0, 3} occurs will be described. The model processing unit 13 outputs, for example, probabilities of {0.55, 0.1, 0.35}. Even if an inconsistency occurs, a high probability is set for the discrimination result of the labeling function with high reliability, and a low probability is set for the discrimination result of the labeling function with low reliability.

A case where the discrimination result is {0, 0, 0}, specifically, it is determined that each labeling function cannot discriminate will be described. Since there is no material for determining the probability of corresponding to each label, the model processing unit 13 outputs, for example, the probabilities of {0.33, 0.33, 0.33}.

As described above, the model processing unit 13 generates the first output data 14 for calculating the probability that each dataset corresponds to each label for the output of the labeling function in consideration of the reliability of each labeling function.

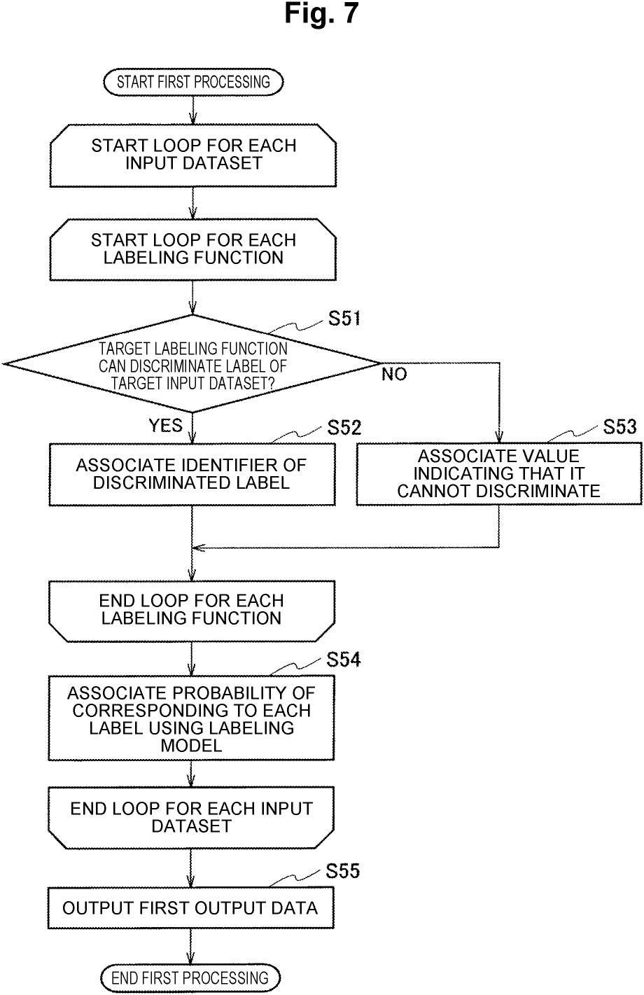

The first processing of the first processing unit 10 will be described with reference to FIG. 7. The process shown in FIG. 7 is an example and is not limited to this.

The first processing unit 10 repeats the processing of steps S51 to S54 for each input dataset of the input data 5.

The first processing unit 10 repeats the processing of steps S51 to S53 for the target input dataset and each labeling function of the function data 6. In step S51, the first processing unit 10 determines whether the target input dataset can be discriminated by the target labeling function. If it can be discriminated, in step S52, the first processing unit 10 associates the discriminated label identifier with the target input dataset and the target labeling function. If it cannot be discriminated, in step S53, the first processing unit 10 associates a value indicating that it cannot be discriminated with the target input dataset and the target labeling function.

When the processing of steps S51 to S53 is completed for the target input dataset and each labeling function, the process proceeds to step S54. In step S54, the first processing unit 10 associates the probabilities of corresponding to each label with the target input dataset using the labeling model. When the processing of steps S51 to S54 is completed for the target input dataset, steps S51 to S54 are performed for a new target input dataset.

When the processing of steps S51 to S54 is completed for each input dataset of the input data 5, the first processing unit 10 outputs the first output data 14 in step S55. The first output data 14 is a set of associations between the input dataset and the probabilities of corresponding to each label, generated in step S54.

When the first output data 14 is generated by the first processing unit 10, the identifying unit 31 identifies the input dataset in which the variation in the probability of corresponding to each label in the first output data 14 among the input datasets satisfies a predetermined condition. When the variation in the probability of corresponding to each label is expressed by a predetermined index, the identifying unit 31 identifies an input dataset in which the variation is larger than a predetermined threshold.

Here, when the probabilities of corresponding to each label are {1,0,0}, the variation of the probability is the smallest. Since it indicates that the reliabilities of all three labeling functions are high, only the first labeling function can discriminate the label and the other labeling functions cannot discriminate for one dataset, the probability that this dataset corresponds to the first label is very high and the variation in the probability is low. On the other hand, when the probabilities of corresponding to each label are {0.33, 0.33, 0.33}, the variation of the probability is the highest. Since it indicates that neither labeling function can discriminate, the probability that the dataset corresponds to any of the labels is very low, and the variation in probability is large.

Therefore, the identifying unit 31 identifies a dataset in which the variation in the probability of corresponding to each label satisfies a predetermined condition as the reference dataset 32. The predetermined condition is that the variation in the probability is large, for example, when each labeling function abstains for a certain input dataset and the probabilities of corresponding to each label are the same, or when a labeling function with low reliability is used and the difference in the probabilities of corresponding to each label is small. The identifying unit 31 identifies an input dataset that meets such a condition as the reference dataset 32.

The predetermined condition may be set by an index of a variation in the probability of corresponding to each label. For example, the predetermined condition is set by entropy. When the probabilities that a certain input dataset corresponds to each class are {p1, p2, p3}, the identifying unit 31 calculates -{p1log (p1) + p2log (p2) + p3log (p3)} as the entropy. If the entropy calculated for a certain input dataset is higher than a predetermined threshold, then that input dataset is identified as the reference dataset 32. The identifying unit 31 identifies an input dataset of which the entropy calculated from the probabilities of corresponding to each label is higher than a predetermined threshold value among the input datasets as the reference dataset 32.

As described above, in the processing device 1 according to the first embodiment, the first processing unit 10 labels the input dataset with the labeling function, calculates the probability that the input dataset corresponds to each label in consideration of the reliability of each labeling function using a labeling model, and outputs the first output data 14. The identifying unit 31 refers to the first output data 14 and identifies an input dataset having a large variation in the probability of corresponding to each label. A new labeling function is generated to label the identified input dataset.

The processing device 1 presents the subject E with the reference dataset 32 for which the labeling function should be created so that the subject E can create a labeling function in the weakly supervised learning, which leads to an improvement in learning accuracy. The subject E can create an effective labeling function at low cost by creating a labeling function based on the presented reference dataset 32 and adding it to the function data 6.

The processing device 1 according to the first embodiment can appropriately identify an input dataset for which a labeling function is newly generated from the probability of corresponding to each label calculated in consideration of the reliability of the labeling function. Since the subject E that newly generates the labeling function only needs to generate a labeling function for labeling the identified input dataset, the processing device 1 can increase the effective labeling functions.

The processing device 1 according to the first embodiment assigns a high probability with a labeling function with high reliability using a labeling model when there is an inconsistency between the labeling functions such that a plurality of labels are assigned to the input dataset by a plurality of labeling functions. Since the processing device 1 evaluates by the continuous value of the output result of the labeling function in consideration of the reliability of the labeling function, the input dataset referenced when newly generating the labeling function can be identified more appropriately.

As described above, the processing device 1 according to the first embodiment can appropriately present the input dataset to which the correct answer should be assigned in the weakly supervised learning. Therefore, it is possible to reduce the cost of generating the labeling function and improve the quality of the labeling function.

### Second Embodiment

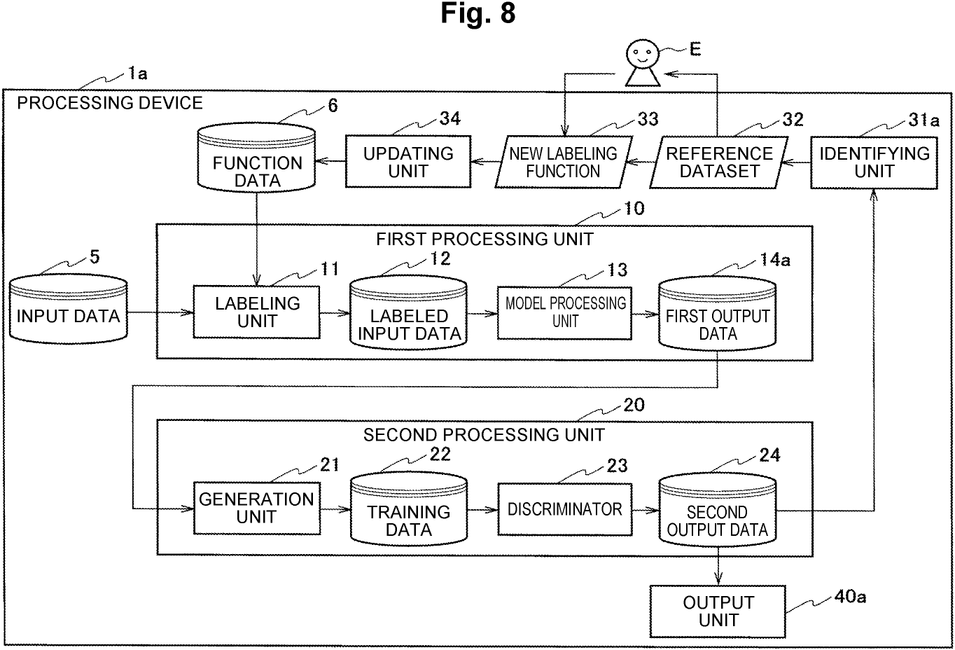

A processing device 1a according to a second embodiment will be described with reference to FIG. 8. The processing device 1a is different from the processing device 1 according to the first embodiment shown in FIG. 1, in that the processing device 1a includes a second processing unit 20, and an identifying unit 31a and an output unit 40a refer to second output data 24 rather than the first output data 14.

The second processing unit 20 inputs a plurality of training datasets in which each input dataset is associated with the label corresponding to the highest probability in the first output data 14 to the discriminator 23 and outputs the second output data 24 that associates the probability of corresponding to each label with each input dataset. Here, a high value is given to the probability of corresponding to the label if determination is made for the labeling function with high reliability that it corresponds to the label, and a low value is given to the probability of corresponding to the label if determination is made for the labeling function with low reliability that it corresponds to the label. The second output data 24 has the same data format as the first output data 14, and is generated by a method different from that of the first output data 14.

The identifying unit 31a according to the second embodiment identifies an input dataset in which the variation in the probability of corresponding to each label in the second output data 24 satisfies a predetermined condition among the input datasets. When the variation in the probability of corresponding to each label is expressed by a predetermined index, the identifying unit 31a identifies an input dataset in which the variation is larger than a predetermined threshold. An input dataset with a large variation in the probability of corresponding to each label has a high priority to be identified as the reference dataset 32, and an input dataset with a small variation in the probability of corresponding to each label has a low priority to be identified as the reference dataset 32. A new labeling function 33 newly created for the input dataset identified from the second output data 24 by the identifying unit 31a is inserted into the function data 6.

With reference to the function data 6 to which the new labeling function 33 is added, the first processing unit 10 again labels each input dataset of the input data 5, and outputs the first output data 14 that associates each input dataset with the probability of corresponding to each label. The second processing unit 20 generates and outputs the second output data 24 from the first output data 14.

The updating process of the function data 6 by the first processing unit 10, the second processing unit 20, the identifying unit 31a, and the like is repeated until a predetermined condition is satisfied. As the predetermined condition, a condition indicating that an appropriate labeling function is accommodated in the function data 6 is set. The predetermined condition is determined by, for example, the number of repetitions, the processing time, and the like until the number of datasets of the reference dataset 32 becomes zero.

The output unit 40a outputs a learning result based on the second output data 24 obtained after the predetermined condition is satisfied. After the newly created labeling function is inserted into the function data 6, the output unit 40a outputs the labels corresponding to the highest probability in each of the input datasets in the second output data 24 obtained by executing the second processing unit 20 in an associated manner.

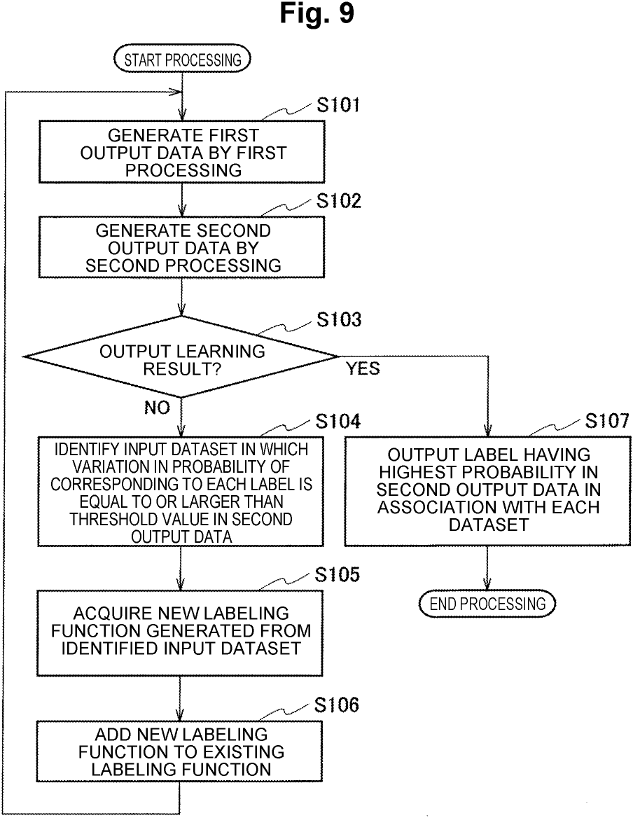

With reference to FIG. 9, the outline of the processing of the processing device 1a according to the second embodiment will be described. The process shown in FIG. 9 is an example and is not limited to this.

First, in step S101, the processing device 1a generates the first output data 14 by the processing of the first processing unit 10. In step S102, the processing device 1a generates the second output data 24 by the processing of the second processing unit 20. The first output data 14 and the second output data 24 are data that associates each input dataset with the probability of corresponding to each label.

In step S103, the processing device 1a determines whether or not the function data 6 accommodates an appropriate function and it is the timing to output the learning result. If it is not the timing to output the learning result, the process proceeds to step S104. If it is the timing to output the learning result, the process proceeds to step S107.

In step S104, the processing device 1a identifies an input dataset in which the variation in the probability of corresponding to each label satisfies a predetermined condition in the second output data 24 as the reference dataset 32. In step S105, the processing device 1a acquires the new labeling function 33 generated for the reference dataset 32 identified in step S104. In step S106, the processing device 1a adds the new labeling function 33 acquired in step S105 to the function data 6 accommodating the existing labeling function. After that, returning to step S101, the processing device 1a refers to the function data 6 to which the new labeling function 33 is added to generate the first output data 14 and the second output data 24.

In step S107, as a learning result, the processing device 1a associates each input dataset with the label having the highest probability in the second output data 24 and outputs the dataset.

### Second Processing Unit

Next, the second processing unit 20 will be described. The second processing unit 20 includes a generation unit 21, training data 22, a discriminator 23, and second output data.

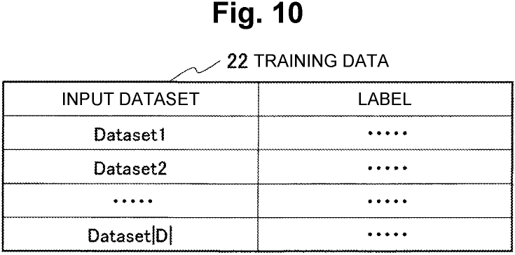

The generation unit 21 generates training data 22 from the first output data 14. The training data 22 is data in which labels are associated with each input dataset, for example, as shown in FIG. 10. The generation unit 21 generates the training data 22 by associating the label with the highest probability with each input dataset in the first output data 14.

The discriminator 23 is a trained machine learning model. The discriminator 23 refers to the training data 22 and outputs the second output data 24 that associates each input dataset with a probability of corresponding to each label. The discriminator 23 refers to the training data 22 to calculate the probability that each input dataset corresponds to each label.

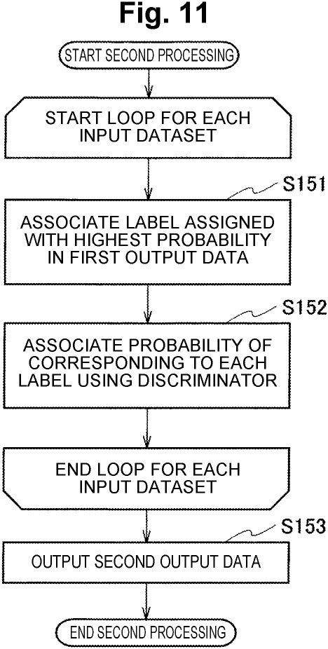

The second process of the second processing unit 20 will be described with reference to FIG. 11. The process shown in FIG. 11 is an example and is not limited to this.

The second processing unit 20 repeats the processing of steps S151 to S152 for each input dataset of the input data 5.

In step S151, the second processing unit 20 associates the target input dataset with the identifier of the label with the highest probability in the first output data. In step S152, the second processing unit 20 associates the target input dataset with the probabilities of corresponding to each label by the discriminator 23. When the processing of steps S151 to S152 is completed for the target input dataset, steps S151 to S152 are performed for a new target input dataset.

When the processing of steps S151 to S152 is completed for each input dataset of the input data 5, the second processing unit 20 outputs the second output data 24 in step S153. The second output data 24 is a set of associations between the input dataset and the probabilities of corresponding to each label generated in step S152.

When the second output data 24 is generated by the second processing unit 20, the identifying unit 31a according to the second embodiment identifies the input dataset in which the variation in the probability of corresponding to each label in the second output data 24 among the input datasets satisfies a predetermined condition similarly to the identifying unit 31 according to the first embodiment. The predetermined condition is that the variation in the probability is large, for example, when each labeling function abstains for a certain input dataset and the probabilities of corresponding to each label are the same, or when a labeling function with low reliability is used and the difference in the probabilities of corresponding to each label is small. The identifying unit 31a identifies an input dataset that meets such a condition as the reference dataset 32.

The predetermined condition may be set by an index of a variation in the probability of corresponding to each label. For example, the predetermined condition is set by entropy. The identifying unit 31a identifies an input dataset of which the entropy calculated from the probabilities of corresponding to each label is higher than a predetermined threshold value among the input datasets as the reference dataset 32.

In the processing device 1a of the second embodiment, the second processing unit 20 that performs different processing from the first processing unit 10 generates the second output data from the first output data 14 and adds, to the function data 6, the new labeling function 33 generated for the input dataset in which the variation of the probability of corresponding to each label satisfies a predetermined condition in the second output data 24. The processing device 1a can identify an input dataset effective for improving the learning result of the discriminator 23 since the second processing unit 20 generates the new labeling function 33 in consideration of the result of the discriminator 23.

### Third Embodiment

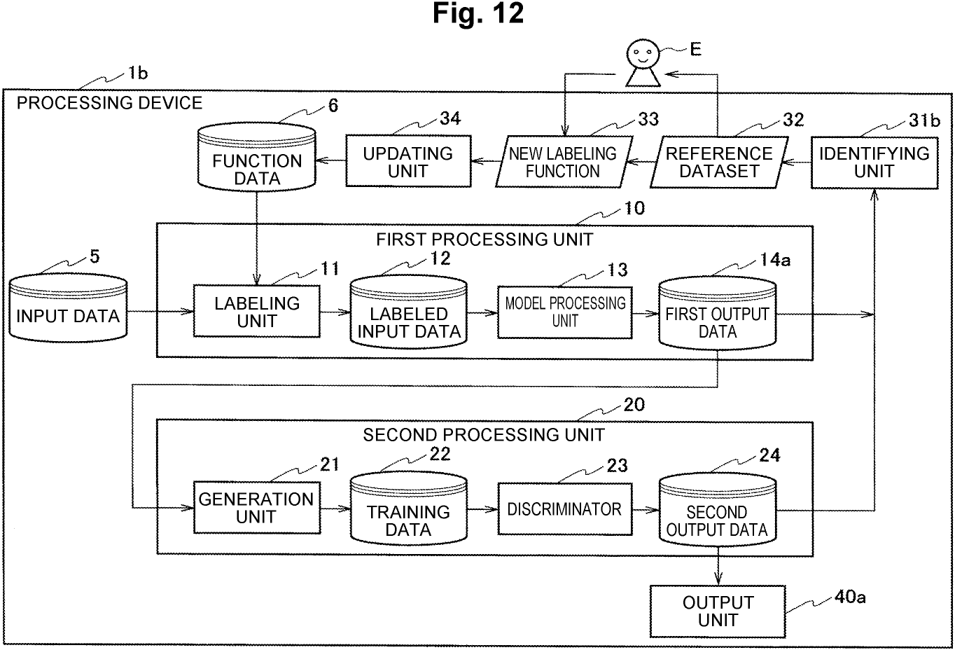

A processing device 1b according to a third embodiment will be described with reference to FIG. 12. The processing device 1b is different from the processing device 1a according to the second embodiment shown in FIG. 8 in that an identifying unit 31b refers to both the first output data 14 and the second output data 24.

In the first embodiment, the reference dataset 32 is identified from the variation in the probability of corresponding to each label in the first output data 14. In the second embodiment, the reference dataset 32 is identified from the variation in the probability of corresponding to each label in the second output data 24. In the third embodiment, the input dataset having a difference in the variations of the probabilities between the first output data 14 and the second output data 24 is identified as the reference dataset 32.

The identifying unit 31b identifies an input dataset in which the distance between a vector of the probability of corresponding to each label in the first output data 14 and a vector of the probability of corresponding to each label in the second output data 24 is equal to or larger than a threshold value among the input datasets as the reference dataset 32. The identifying unit 31b inserts a new labeling function 33 newly created for the input dataset identified from the distance between the vector of the probability of corresponding to each label in the first output data 14 and the vector of the probability of corresponding to each label in the second output data 24 into the function data 6.

When the identifying unit 31b finds a difference between the result obtained by the first processing unit 10 and the result obtained by the second processing unit 20 for a certain input dataset, it is believed that an appropriate labeling function is not accommodated in the function data 6. Therefore, the identifying unit 31b identifies an input dataset having a difference between the result obtained by the first processing unit 10 and the result obtained by the second processing unit 20 as the reference dataset 32, and accommodates a new labeling function for the reference dataset 32 in the function data 6.

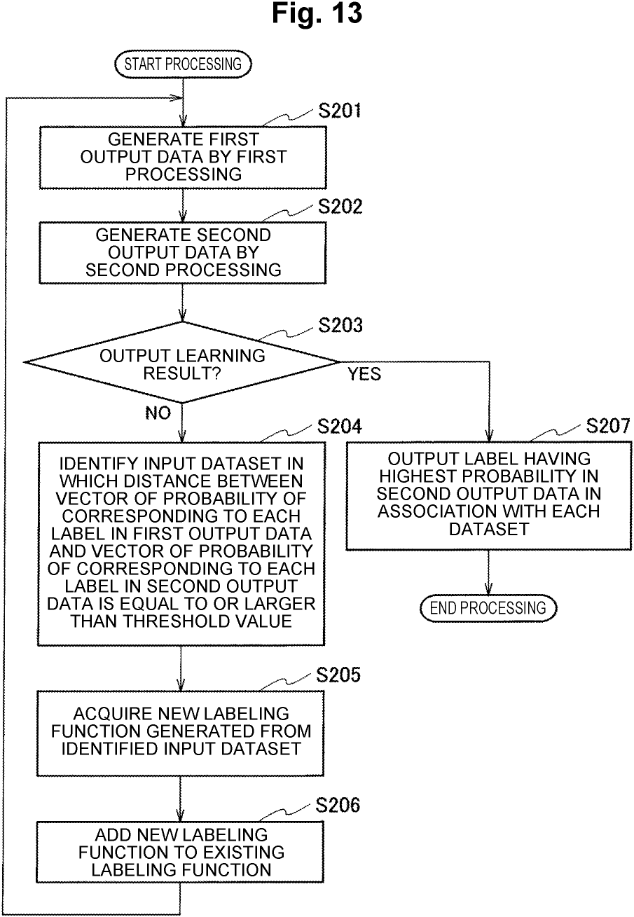

With reference to FIG. 13, the outline of the processing of the processing device 1b according to the third embodiment will be described. The process shown in FIG. 13 is an example and is not limited to this.

First, in step S201, the processing device 1b generates the first output data 14 by the processing of the first processing unit 10. In step S202, the processing device 1b generates the second output data 24 by the processing of the second processing unit 20. The first output data 14 and the second output data 24 are data that associates each input dataset with the probability of corresponding to each label.

In step S203, the processing device 1b determines whether or not the function data 6 accommodates an appropriate function and it is the timing to output the learning result. If it is not the timing to output the learning result, the process proceeds to step S204. If it is the timing to output the learning result, the process proceeds to step S207.

In step S204, the processing device 1b identifies an input dataset in which the distance between a vector of the probability of corresponding to each label in the first output data 14 and a vector of the probability of corresponding to each label in the second output data 24 is equal to or larger than a threshold value among the input datasets as the reference dataset 32. In step S205, the processing device 1b acquires the new labeling function 33 generated for the reference dataset 32 identified in step S204. In step S206, the processing device 1b adds the new labeling function 33 acquired in step S205 to the function data 6 accommodating the existing labeling function. After that, returning to step S201, the processing device 1b refers to the function data 6 to which the new labeling function 33 is added to generate the first output data 14 and the second output data 24.

In step S207, as a learning result, the processing device 1b associates each input dataset with the label having the highest probability in the second output data 24 and outputs the dataset.

In the third embodiment, the processing device 1b identifies the reference dataset 32 for identifying the new labeling function 33 by focusing on the difference between the output results of the first output data 14 and the second output data 24. The processing device 1b can identify the reference dataset 32 from a viewpoint different from those of the first embodiment and the second embodiment.

### Fourth Embodiment

Three methods have been described as methods for identifying the input dataset as the reference dataset 32. In the first embodiment, a method of identifying the input dataset from the variation of the probability of corresponding to each label in the first output data 14 has been described. In the second embodiment, a method of identifying the input dataset from the variation of the probability of corresponding to each label in the second output data 24 has been described. In the third embodiment, a method of identifying the input dataset from the distance between the probability of corresponding to each label in the first output data 14 and the probability of corresponding to each label in the second output data 24 has been described.

In the fourth embodiment, the input dataset may be identified by integrating two or more of the three identifying methods.

For example, the identifying unit 31 may calculate an index in which the respective indices in the two or three identifying methods are integrated, and identify the input dataset to be the reference dataset 32 according to the integrated indices. The integrated indices have a positive correlation with each of the indices calculated by the three identifying methods. The identifying unit 31 outputs each input dataset identified in descending order of the integrated indices as the reference dataset 32.

According to the fourth embodiment, the diversity of the function data 6 can be efficiently realized by generating a new labeling function for the input dataset selected from a plurality of viewpoints.

### Verification

Here, the verification of the processing device 1 according to the embodiment of the present invention will be described. Here, as shown in the fourth embodiment, an index having a positive correlation with the indices described in the first embodiment to the third embodiment is used.

As verification, question classification will be explained as an example. Question classification is a problem of classifying what is being asked about a question. The TREC6 (TREC: Text REtrieval Conference) dataset is classified into six labels: ABBR (abbreviation), DESC (description), ENTY (entities), LOC (locations), HUM (human beings or organizations), and NUM (numerical values). The input dataset of the input data 5 is a sentence starting with a question.

An example of the labeling function is shown below. The labeling function shown in Table 1 indicates that it assigns the correct answer “LOC” if the question starts with “Where” and abstains in other cases.

def 1f_where:
if sentence.startswith (‘Where’):
return ‘LOC’
return ‘ABSTAIN’

The open source software Snorkel is used as the labeling model referred to by the model processing unit 13. Bidirectional LSTM (Long Short Term Memory) is used for the discriminator 23.

A method of calculating the priority when the identifying unit 31 identifies the reference dataset 32 from the input dataset of the input data 5 will be described. Since the TREC6 dataset is classified into six classes, the output of the labeling model is the probability of each of the six labels. The identifying unit 31 refers to the first output data 14 to calculate the entropy of the probability for each input dataset as a variation in the probability of corresponding to each label in the first output data 14.

The output of the discriminator 23 for each data also has the probability of each of the six classes. The identifying unit 31 refers to the second output data 24 as a variation of the probability of corresponding to each label in the second output data 24, and calculates the entropy of the probability for each input dataset.

As the distance between the probability of corresponding to each label in the first output data 14 and the probability of corresponding to each label in the second output data 24, the identifying unit 31 calculates 1 - cosθ for each input dataset from a cosine similarity cosθ of the vectors of both probabilities.

As the priority in the verification, the product or logarithmic sum of the indices including the entropy calculated from the first output data 14, the entropy calculated from the second output data 24, and 1-cosθ calculated from the similarity cosθ of the probabilities of the first output data 14 and the second output data 24 is used.

The identifying unit 31 identifies ten questions having the higher priorities as the reference dataset 32 from the input data 5 and presents the identified questions to the subject E. The subject E generates a new labeling function 33 that can be applied to many questions in the presented questions while considering the priorities of each question. The new labeling function 33 is inserted into the function data 6.

For example, it is assumed that ten sentences shown in Table 2 are presented as the reference dataset 32. In Table 2, sentences are arranged in descending order of priority. It can be seen that it may be good that a labeling function that discriminates a sentence starting with “How + adjective representing quantities” such as “How many” and “How far” as the label “NUM” from the ten sentences shown in Table 2 is generated.

How many yards are in 1 mile?

How many questions are on this thing?

Tell me what city the Kentucky Horse Park is near?

How many cullions does a male have?

How many horses are there on a polo team?

How far is the longest hole in 1 on any golf course and where did it happen?

Which city has the oldest relationship as a sister city with Los Angeles?

How many events make up the decathlon?

How many neurons are in the human brain?

How many types of cheese are there in France?

Here, for verification, a case will be described in which six labeling functions are set in the function data 6 after preparing labeling functions that can be added in advance, and then the labeling functions are added one by one. In order to imitate the operation of the subject E, a computer calculated the priorities of the sentences that can give the correct answer by adding a labeling function with respect to the ten sentences shown in the reference dataset 32 presented by the identifying unit 31 and added the labeling function with the highest priority to the function data 6. When the candidates for the labeling function abstain for the questions presented as the reference dataset 32, the same processing is performed for the question having the next highest priority in the reference dataset 32.

Here, as verification, in addition to the case where the proposed method according to the embodiment is used, the case where the method described in Non-Patent Literature 1 is used, the case where sentences are randomly added, and the case where labeling functions are randomly added are used. In any of the methods, the six labeling functions initially set in the function data 6 are the same.

In the method described in Non-Patent Literature 1, it is extended to multi-class identification, and the question abstained by all labeling functions is given the first highest priority, and the question which has been voted for but for which there are multiple tie-breaking tops is given the second highest priority. If the number of sentences having the first highest priority is more than 10, ten sentences are randomly selected from the sentences having the first highest priority. If the number is smaller than 10, ten sentences are randomly selected from the sentences having the first highest priority, or otherwise, when only a number, less than ten, of sentences can be selected therefrom, ten sentences are randomly selected not only from the sentences having the first highest priority but also from the questions having the second highest priority. A sentence that can be most frequently applied to all labeling function candidates among the ten sentences is added as the new labeling function. If the number of applicable sentences is the same, the sentence is randomly selected from them.

In the method of randomly adding sentences, ten sentences to be presented to the subject E are randomly selected, and a sentence that can be most frequently applied to all labeling function candidates among the selected ten sentences is added as a new labeling function. If the number of applicable sentences is the same, the sentence is randomly selected from them.

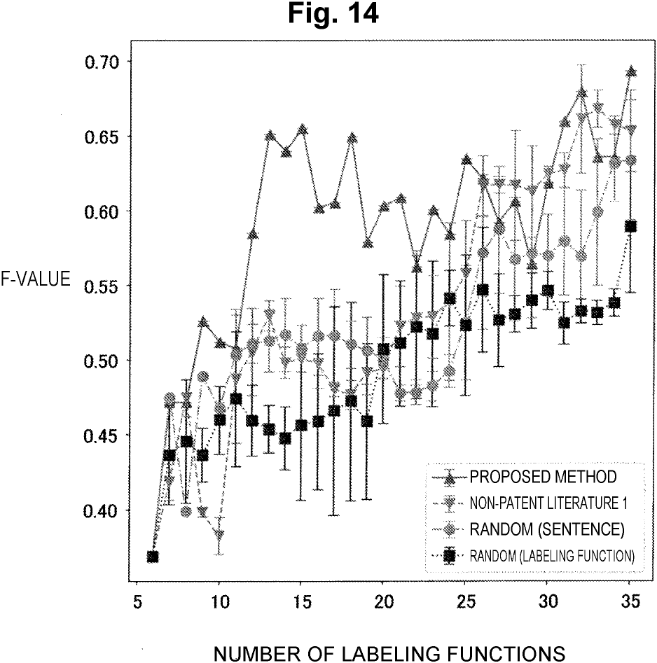

The result of adding the labeling function by the four methods is shown in FIG. 14. The vertical axis is the macro F value, which is an index of verification, and the horizontal axis is the number of labeling functions.

When the proposed method according to the embodiment is used, the F value is higher than that of the other methods in the state where a small number of labeling functions are added. Therefore, the processing device 1 according to the embodiment of the present invention can add a labeling function with high accuracy and efficiency.

The processing device 1 of the present embodiment described above is a general-purpose computer system including, for example, a CPU (Central Processing Unit, processor) 901, a memory 902, a storage 903 (HDD: Hard Disk Drive, SSD: Solid State Drive), a communication device 904, an input device 905, and an output device 906. In this computer system, each function of the processing device 1 is realized by the CPU 901 executing the processing program loaded on the memory 902.

The processing device 1 may be implemented as one computer or may be implemented as a plurality of computers. Further, the processing device 1 may be a virtual machine implemented on a computer.

The program of the processing device 1 may be stored in a computer-readable recording medium such as HDD, SSD, USB (Universal Serial Bus) memory, CD (Compact Disc), DVD (Digital Versatile Disc), or may be distributed via a network.

The present invention is not limited to the above-described embodiments, and many modifications can be made within the scope of the gist thereof.

REFERENCE SIGNS LIST

| | |
|---|---|
| 1 | Processing device |
| 5 | Input data |
| 6 | Function data |
| 10 | First processing unit |
| 11 | Labeling unit |
| 12 | Labeled input data |
| 13 | Model processing unit |
| 14 | First output data |
| 20 | Second processing unit |
| 21 | Generation unit |
| 22 | Training data |
| 23 | Discriminator |
| 24 | Second output data |
| 31 | Identifying unit |
| 32 | Reference dataset |
| 33 | New labeling function |
| 34 | Updating unit |
| 901 | CPU |
| 902 | Memory |
| 903 | Storage |
| 904 | Communication device |
| 905 | Input device |
| 906 | Output device |
| E | Subject |

1. A processing device comprising:
a processor; and
a memory device storing instructions that, when executed by the processor, configure the processor to:
refer to function data including a labeling function that labels an input dataset or abstain if it cannot label, to output first output data that associates each input dataset with a probability of corresponding to each label from a result of labeling the input dataset by the labeling function; and
identify an input dataset in which a variation in the probability of corresponding to each label in the first output data satisfies a predetermined condition among the input datasets, wherein
a labeling function newly created for the input dataset identified from the first output data is inserted into the function data.

2. The processing device according to claim 1, wherein the processor is further configured to:
output a label corresponding to a highest probability in association with each input dataset in the first output data after the newly created labeling function is inserted into the function data.

3. The processing device according to claim 1, wherein the processor is further configured to:
input a plurality of training datasets in which each input dataset is associated with a label corresponding to the highest probability in the first output data, to a discriminator and outputs second output data that associates each input dataset with a probability of corresponding to each label, wherein
identify, among the input datasets, an input dataset in which a variation in the probability of corresponding to each label in the second output data satisfies a predetermined condition, and
a labeling function newly created for the input dataset identified from the second output data is inserted into the function data.

4. The processing device according to claim 3, wherein the processor is configured to:
identify, among the input datasets, an input dataset in which a distance between a vector of the probability of corresponding to each label in the first output data and a vector of the probability of corresponding to each label in the second output data is equal to or larger than a threshold value, and
a labeling function newly created for the input dataset from the distance between the vector of the probability of corresponding to each label in the first output data and the vector of the probability of corresponding to each label in the second output data is inserted into the function data.

5. The processing device according to claim 3, the processor is further configured to:
output a label corresponding to a highest probability in association with each input dataset in second output data after the newly created labeling function is inserted into the function data.

6. The processing device according to claim 1, wherein
a high value is given to the probability of corresponding to the label if determination is made for a labeling function with high reliability that it corresponds to the label, and a low value is given to the probability of corresponding to the label if determination is made for a labeling function with low reliability that it corresponds to the label.

7. A processing method for causing a computer to execute:
referring to function data including a labeling function that labels an input dataset or abstain if it cannot label, to output first output data that associates each input dataset with a probability of corresponding to each label from a result of labeling the input dataset by the labeling function; and
identifying an input dataset in which a variation in the probability of corresponding to each label in the first output data satisfies a predetermined condition among the input datasets, wherein
a labeling function newly created for the input dataset identified from the first output data in the identifying step is inserted into the function data.

8. A non-transitory computer readable medium storing a program, wherein executing of the program causes a computer to function as the processing device according to claim 1.

9. The processing device according to claim 4, the processor is further configured to: output a label corresponding to a highest probability in association with each input dataset in second output data after the newly created labeling function is inserted into the function data.

10. The processing device according to claim 2, wherein a high value is given to the probability of corresponding to the label if determination is made for a labeling function with high reliability that it corresponds to the label, and a low value is given to the probability of corresponding to the label if determination is made for a labeling function with low reliability that it corresponds to the label.

11. The processing device according to claim 3, wherein a high value is given to the probability of corresponding to the label if determination is made for a labeling function with high reliability that it corresponds to the label, and a low value is given to the probability of corresponding to the label if determination is made for a labeling function with low reliability that it corresponds to the label.

12. The processing device according to claim 4, wherein a high value is given to the probability of corresponding to the label if determination is made for a labeling function with high reliability that it corresponds to the label, and a low value is given to the probability of corresponding to the label if determination is made for a labeling function with low reliability that it corresponds to the label.

13. The processing device according to claim 5, wherein a high value is given to the probability of corresponding to the label if determination is made for a labeling function with high reliability that it corresponds to the label, and a low value is given to the probability of corresponding to the label if determination is made for a labeling function with low reliability that it corresponds to the label.

14. A non-transitory computer readable medium storing a program, wherein executing of the program causes a computer to function as the processing device according to claim 2.

15. A non-transitory computer readable medium storing a program, wherein executing of the program causes a computer to function as the processing device according to claim 3.

16. A non-transitory computer readable medium storing a program, wherein executing of the program causes a computer to function as the processing device according to claim 4.

17. A non-transitory computer readable medium storing a program, wherein executing of the program causes a computer to function as the processing device according to claim 5.

18. A non-transitory computer readable medium storing a program, wherein executing of the program causes a computer to function as the processing device according to claim 6.
